(19) United States
(12) Patent Application Publication
(10) Pub. No.: US 2025/0257544 A1
(43) Pub. Date: Aug. 14, 2025

(54) METHOD FOR INSTALLATION OF AN OFFSHORE WIND TURBINE FOUNDATION MONOPILE

(71) Applicant: Itrec B.V., SCHIEDAM (NL)

(72) Inventor: Pieter Dirk Melis VAN DUIVENDIJK, SCHIEDAM (NL)

(73) Assignee: Itrec B.V., SCHIEDAM (NL)

(21) Appl. No.: 18/857,005

(22) PCT Filed: Apr. 13, 2023
(86) PCT No.: PCT/EP2023/059663

§ 371 Date: Oct. 15, 2024

(30) Foreign Application Priority Data
Apr. 13, 2022 (NL) 2031570

(51) Int. Cl. E02D 27/42; E02D 7/18; E02D 7/22; E02D 7/24; E02D 27/52

(52) U.S. Cl. CPC E02D 27/425; E02D 7/18; E02D 7/22; E02D 7/24; E02D 27/525

(57) ABSTRACT

An offshore wind turbine foundation monopile in a seabed, the monopile having a foot end, a top end, and a longitudinal axis, by revolving the monopile about the longitudinal axis, such that the monopile makes multiple revolutions while being driven into the seabed.

The present invention relates to the field of installing an offshore wind turbine foundation monopile, i.e. a hollow tubular pile having a vertical centreline, a top end, and an open foot end vertically into the soil, e.g. into the seabed. For example, the pile is a large diameter pile having an outer diameter at the open foot end of at least 5 meters. For example, the pile is a so-called monopile of an offshore wind turbine.

Practical embodiments of monopiles nowadays envisaged include monopiles having a diameter between 5 and 12 meters, and lengths between 60 and 120 meters. In embodiments, the wall thickness of the pile is more than 10 centimetres. For example, the pile may have a mass of more than 1000 tonnes, e.g. more than 2000, or even more than 3000 tonnes.

In practical embodiments, the pile is a steel pile, e.g. composed of ring segments that are welded end to end, with each ring segment being composed of arc segments that are welded to one another to form a ring.

The pile may include a tapered or conical section, e.g. between a larger diameter lower pile section and a smaller diameter pile top section. In another embodiment, the pile has a uniform cross-section over its length. Preferably, the pile has a circular horizontal cross-section over its entire length. In an embodiment, the top end of the pile is provided with a connection structure for a wind turbine mast, possibly with the interface of a transition piece, e.g. a flange for a bolt connection and/or a slip-joint connection structure.

Vibratory pile hammers are generally known. They typically comprise a system of counter-rotating eccentric weights, powered by hydraulic motors. Vibratory pile hammers are designed so that horizontal vibrations cancel out, while vertical vibrations are transmitted into the pile. The vibratory pile hammer is positioned over the pile with an excavator or crane, and is fastened to the pile by a clamp and/or bolts. Vibratory hammers can drive or extract a pile. Extraction is commonly used to recover steel I-beams used in temporary foundation shoring. Hydraulic fluid is for example supplied to the driver by a diesel engine-powered pump mounted in a trailer or van, and connected to the driver head via hoses. When the pile driver is connected to a dragline excavator, it is powered by the excavator's diesel engine. Vibratory pile drivers are often chosen to mitigate noise, as when the construction is near residences or office buildings, or when there is insufficient vertical clearance to permit use of a conventional pile hammer (for example when retrofitting additional piles to a bridge column or abutment footing). Hammers are available with several different vibration rates, ranging from 1200 vibrations per minute to 2400 vibrations per minute. The vibration rate chosen is influenced by soil conditions and other factors, such as power requirements and equipment cost.

The invention relates to pile driving method for driving a hollow tubular pile having a vertical centreline, a top end and an open foot end vertically into the soil, e.g. into the seabed, e.g. a large diameter pile having an outer diameter at the open foot end of at least 5 meters, e.g. a monopile of an offshore wind turbine. The invention furthermore provides a monopile, a system for driving a monopile into the seabed, a vessel provided with such a system and a template.

For example from WO2020/207903 it is known to use a vibrating force directed along the longitudinal axis of the monopile, to drive the monopile into the soil. In addition to the vibrational driving force, water can be used to remove soil from below the foundation pile. Furthermore, from WO2017/203023 it is known to push soil in the radially outward direction away from below the monopile. These prior art installation processes require a complicated device to be provided at the foot end of the monopile. At the end of the installation process, the device has to be excavated such that it can be used for installation of another foundation pile. The excavation of such a complicated device is difficult and time consuming.

The invention aims to provide an improved, more in particular a more efficient monopile installation process.

According to the claimed invention, the monopile is revolved about a longitudinal axis of the monopile, i.e. about the vertical centreline of the hollow tubular pile, such that the monopile makes multiple revolutions during the monopile installation process.

The monopile installation process is the process of driving the monopile, vertically, into the seabed. The pile driving force, i.e. the force that drives the pile in the axial direction into the sea floor, can be generated by vibration devices, impact hammers, a pile revolver in combination with one or more helical ribs and/or excavating blades mounted on the monopile.

According to the invention, the monopile is revolved about the longitudinal axis of the monopile during the installation process, i.e. during the installation of the monopile.

A method according to claim 1 for installation of an offshore wind turbine foundation monopile in a seabed, the monopile having a foot end, a top end, and a longitudinal axis, comprises:
supporting the monopile in an upright position with the foot end on the sea floor;
revolving the monopile about the longitudinal axis, such that the monopile makes multiple revolutions while being driven into the seabed.

Revolving the entire monopile, instead of for example vibrating the monopile in the circumferential direction, such that the monopile makes multiple revolutions while being driven into the seabed, allows for an improved, more in particular a more efficient installation process.

Vibration is a movement wherein the object is moved in one direction and subsequently is moved, over about the same distance, in the opposite direction.

Revolving the monopile during the installation process may cause removal of the soil below the foot end of the monopile. This is in particular the case when the monopile is provided with excavating blades at the foot end of the monopile.

Revolving the monopile during the installation process may generate a pile driving force, i.e. a force in the axial direction of the monopile. This is in particular the case when the monopile is provided with one or more helical ribs on its inside and/or outside surface, which helical rib or ribs form threading that engages the soil and thus transforms a circumferential force into an axial force.

Revolving the monopile during the installation process may reduce the friction between the monopile and the soil. This is in particular the case when the monopile is revolved using vibration devices.

In an embodiment, a method according to the invention furthermore comprises using gravitational forces to press monopile into the soil, for example by providing a weight at the top end of the monopile, for example by mounting a water ballast tank on the top end of the mono pile.

In an embodiment, a method according to the invention furthermore comprises fluidising the soil by injecting water into the soil at the foot end of the monopile, and allowing the fluidised soil to flow away from below the monopile.

In an embodiment, a method according to the invention furthermore comprises vibrating the monopile in a circumferential direction.

In an embodiment, a method according to the invention furthermore comprises vibrating the monopile in an axial direction.

In an embodiment, in a further method according to the invention, the frequency of the vibration is between 10 and 500 Hz.

In an embodiment, a further method according to the invention, the vibrating is provided using three or more vibration devices, and wherein the vibration devices vibrate a-synchronous, and thus generate peaks (in phase vs out-off phase).

Vibration is a movement wherein the object is moved in one direction and subsequently is moved, over about the same distance, in the opposite direction. A vibration device according to the invention is configured to move an object a relatively large distance in a first direction and a relative small distance in a second opposite direction, such that the object is overall moved in the first direction.

Vibration devices typically comprise a system of counter-rotating eccentric weights, powered by hydraulic motors. For rotating a monopile about a vertical axis, the vibration devices are designed so that vertical vibrations cancel out, while horizontal vibrations are transmitted into the pile. According to the inventin, multiple vibration devices are set up along the circumference of the pile to be rotated, the vibration devices preferably each generating a pile rotating force.

In an embodiment, in a further method according to the invention the vibration device engages the outside surface of the foundation pile and/or is mounted at the top end onto the pile.

In an embodiment, in a further method according to the invention, the multiple vibration devices are tuned such that they generate an interference pattern comprising peaks that generate a net circumferential displacement in a revolution direction, and thus revolve the monopile about the longitudinal axis of the monopile.

In an embodiment, in a further method according to the invention, the vibration is achieved by using a number of individual vibration devices each comprise a hydraulic motor connected to a rotating eccentric mass.

In an embodiment, in a further method according to the invention, the axis of rotation of the eccentric masses are directed in a radial direction with respect to the monopile, to enable the vibration devices to generate a circumferentially directed vibration force.

In an embodiment, a vibration device according to the invention comprises multiple rotating eccentric masses. The vibration device is configured such that vertical vibrations cancel out, while horizontal vibrations, perpendicular to a plane comprising the central axis of the foundation pile, are transmitted into the pile. Furthermore, the vibration device is tuned, i.e. the rotating eccentric weights of the vibration device are set up, such that an interference pattern is generated comprising peaks that generate a net circumferential displacement in a revolution direction. Thus, the vibration device is tuned such that it generates a net circumferential displacement in a revolution direction.

The invention furthermore provides a method for installation of an offshore wind turbine foundation monopile in a seabed, the monopile having a foot end, a top end, and a longitudinal axis, wherein the method comprises:
supporting the monopile in an upright position with the foot end on the sea floor;
revolving the monopile about the longitudinal axis by vibrating the monopile in a circumferential direction, such that the monopile makes multiple revolutions while being driven into the seabed, wherein the vibrating is provided using three or more vibration devices, and wherein the vibration devices vibrate a-synchronous, and thus generate peaks (in phase vs out-off phase), and
preferably wherein the monopile is at the foot end provided with excavating blades for removing soil from below the foundation pile and/or wherein the monopile is at an inside surface and/or an outside surface provided with one or more helical ribs to provide the respective inside and/or outside surface of the monopile with a threading to enable the monopile to be screwed into the seabed and/or to remove soil in an axial direction away from the foot end of the monopile.

Preferably, the method furthermore comprises using gravitational forces to press monopile into the soil, for example by providing a weight at the top end of the monopile, for example by mounting a water ballast tank on the top end of the mono pile, and/or the method furthermore comprises fluidising the soil by injecting water into the soil at the foot end of the monopile, and allowing the fluidised soil to flow away from below the monopile.

While the monopile is being driven into the seabed, by revolving the monopile about the longitudinal axis by vibrating the monopile in a circumferential direction such that the monopile makes multiple revolutions, the monopile is preferably supported by a vessel mounted pile gripper and/or a sea floor mounted template.

The invention furthermore provides a method for installation of an offshore wind turbine foundation monopile in a seabed, the monopile having a foot end, a top end, and a longitudinal axis, wherein the method comprises:
supporting the monopile in an upright position with the foot end on the sea floor;
revolving the monopile about the longitudinal axis by vibrating the monopile in a circumferential direction, such that the monopile makes multiple revolutions while being driven into the seabed, wherein the vibration is achieved by using a number of individual vibration devices each comprise a hydraulic motor connected to a rotating eccentric mass, and wherein multiple vibration devices are tuned such that they generate an interference pattern comprising peaks that generate a net circumferential displacement in a revolution direction, and thus revolve the monopile about the longitudinal axis of the monopile, and
preferably wherein the monopile is at the foot end provided with excavating blades for removing soil from below the foundation pile and/or wherein the monopile is at an inside surface and/or an outside surface provided with one or more helical ribs to provide the respective inside and/or outside surface of the monopile with a threading to enable the monopile to be screwed into the seabed and/or to remove soil in an axial direction away from the foot end of the monopile.

Preferably, the method furthermore comprises using gravitational forces to press monopile into the soil, for example by providing a weight at the top end of the monopile, for example by mounting a water ballast tank on the top end of the mono pile, and/or the method furthermore comprises fluidising the soil by injecting water into the soil at the foot end of the monopile, and allowing the fluidised soil to flow away from below the monopile.

While the monopile is being driven into the seabed, by revolving the monopile about the longitudinal axis by vibrating the monopile in a circumferential direction such that the monopile makes multiple revolutions, the monopile is preferably supported by a vessel mounted pile gripper and/or a sea floor mounted template.

The invention furthermore provides an offshore wind turbine foundation monopile, the monopile having a foot end, a top end, and a longitudinal axis, wherein the monopile is configured to be revolved about the longitudinal axis of the monopile during installation of the monopile in the seabed, wherein
the monopile is at the foot end provided with excavating blades for removing soil from below the foundation pile and/or wherein the monopile is at an inside surface and/or an outside surface provided with one or more helical ribs to provide the respective inside and/or outside surface of the monopile with a threading to enable the monopile to be screwed into the seabed and/or to remove soil in an axial direction away from the foot end of the monopile.
   and/or
the monopile is provided with one or more fluidisation conduits extending in the longitudinal direction of the monopile for channeling fluidisation fluid, for example water, to the foot end of the monopile and preferably with multiple fluidisation fluid nozzles along the circumference of the foot end of the monopile for dispensing jets of fluidisation fluid at the foot end of the monopile during installation of the monopile;
   and/or
the monopile is configured to be engaged by a pile revolver, for example is provided with radially extending teeth for cooperating with driving teeth of a pile revolving drive and/or is provided with seats for one or more vibration devices at the top end of the monopile.

In a further embodiment, the monopile has a diameter of at least 8 meter, for example has a diameter of 10 meter, preferably has a diameter of 12 meter.

In a further embodiment, the monopile has a length of at least 30 meter, for example has a length of more than 40 meter.

In a further embodiment, the monopile is at the foot end provided with multiple excavation blades, which excavation blades are mounted to a bottom surface of the monopile or to a flange mounted to the bottom end of the monopile, wherein the excavation blades extend at an angle with the circumference of the monopile to force soil in a radial direction away from below the monopile.

In a further embodiment, the excavation blades alternatingly extend inwards and outwards relative to the circumference of the monopile such that soil is pushed inward and outward during the installation process.

The invention furthermore provides an offshore wind turbine foundation monopile, the monopile having a foot end, a top end, and a longitudinal axis, wherein the monopile is configured to be revolved about the longitudinal axis of the monopile during installation of the monopile in the seabed, wherein
the monopile is at the foot end provided with excavating blades for removing soil from below the foundation pile and/or wherein the monopile is at an inside surface and/or an outside surface provided with one or more helical ribs to provide the respective inside and/or outside surface of the monopile with a threading to enable the monopile to be screwed into the seabed and/or to remove soil in an axial direction away from the foot end of the monopile.

The invention furthermore provides a monopile installation system, the system comprising;
a monopile support for supporting the monopile in an upright position with the foot end of the monopile on the sea floor, e.g. a vessel mounted pile gripper or a sea floor mounted template;
a monopile revolver for revolving the monopile about a central axis during installation of the monopile, wherein for example the monopile drive comprises multiple vibration devices to be mounted on the top end of the monopile or one or more drives configured to engage an outside surface of the monopile and enact a circumferential pile revolving force on that surface.

In a further embodiment, the installation system furthermore comprises: a pile drive for generating an axial pile driving force, for example an hydraulic impact hammer or one or more vibration devices.

In a further embodiment, the installation system furthermore comprises a monopile according to the invention.

The invention furthermore provides a monopile installation system, the system comprising;
a monopile support for supporting the monopile in an upright position with the foot end of the monopile on the sea floor, e.g. a vessel mounted pile gripper or a sea floor mounted template;
a monopile revolver for revolving the monopile about a central axis during installation of the monopile, wherein the monopile revolver comprises multiple vibration devices to be mounted on the top end of the monopile for revolving the monopile about the longitudinal axis by vibrating the monopile in a circumferential direction, and wherein multiple vibration devices are tuned such that they generate an interference pattern comprising peaks that generate a net circumferential displacement in a revolution direction, and thus revolve the monopile about the longitudinal axis of the monopile.

The invention furthermore provides a monopile installation system, the system comprising;
a monopile support for supporting the monopile in an upright position with the foot end of the monopile on the sea floor, e.g. a vessel mounted pile gripper or a sea floor mounted template;
a monopile revolver for revolving the monopile about a central axis during installation of the monopile, wherein the monopile revolver preferably comprises multiple vibration devices to be mounted on the top end of the monopile for revolving the monopile about the longitudinal axis by vibrating the monopile in a circumferential direction, and wherein multiple vibration devices are tuned such that they generate an interference pattern comprising peaks that generate a net circumferential displacement in a revolution direction, and thus revolve the monopile about the longitudinal axis of the monopile.
an offshore wind turbine foundation monopile, the monopile having a foot end, a top end, and a longitudinal axis, wherein the monopile is configured to be revolved about the longitudinal axis of the monopile during installation of the monopile in the seabed, wherein
   the monopile is at the foot end provided with excavating blades for removing soil from below the foundation pile and/or wherein the monopile is at an inside surface and/or an outside surface provided with one or more helical ribs to provide the respective inside and/or outside surface of the monopile with a threading to enable the monopile to be screwed into the seabed and/or to remove soil in an axial direction away from the foot end of the monopile.
and/or
   the monopile is provided with one or more fluidisation conduits extending in the longitudinal direction of the monopile for channeling fluidisation fluid, for example water, to the foot end of the monopile and preferably with multiple fluidisation fluid nozzles along the circumference of the foot end of the monopile for dispensing jets of fluidisation fluid at the foot end of the monopile during installation of the monopile;
and/or
   the monopile is configured to be engaged by a pile revolver for revolving the monopile about the central axis during installation of the monopile, wherein the pile revolver comprises multiple vibration devices, to be mounted on the top end of the monopile, for revolving the monopile about the longitudinal axis by vibrating the monopile in a circumferential direction, and wherein multiple vibration devices are tuned such that they generate an interference pattern comprising peaks that generate a net circumferential displacement in a revolution direction, and thus revolve the monopile about the longitudinal axis of the monopile.

The invention furthermore provides a template configured to support a monopile in an upright position and/or provided with a monopile revolver for revolving a monopile about the longitudinal axis during installation of the monopile.

In a further embodiment, the template is installed on the sea floor, to support the monopile in the upright position and/or to support the pile rotation device

The invention furthermore provides a vessel, e.g. a jack-up vessel, provided with a system according to the invention.

The invention furthermore provides a monopile revolver, to be mounted on the top end of a monopile for an offshore wind turbine, for revolving the monopile about a central axis of the monopile during installation of the monopile, wherein the monopile revolver comprises multiple vibration devices that are tuned such that they generate an interference pattern comprising peaks that generate a net circumferential displacement in a revolution direction, and thus revolve the monopile about the longitudinal axis of the monopile.

Further objects, embodiments and elaborations of the monopile and the method according to the invention will be apparent from the following description, in which the invention is further illustrated and elucidated on the basis of a number of exemplary embodiments, with reference to the drawings.

### In the Drawings,

FIG. 1 shows a side view in cross section of a monopile according to the invention, the monopile being provided with multiple vibration devices at a top end thereof;

FIG. 2 shows a bottom view of the monopile of FIG. 1;

FIG. 3 shows a partial cross sectional side view in close up of the monopile of claim 1;

FIG. 4 shows a partial bottom view in close up of the monopile of claim 1;

FIG. 5 shows what an interference pattern of vibration devices may look like, the interference pattern resulting in periodical peaks of a torsional force exerted on the monopile;

FIG. 6 shows what an interference pattern of vibration devices may look like, the interference pattern resulting in periodical peaks of a torsional force exerted on the monopile, the force revolving the monopile;

FIG. 7 shows a perspective view of another monopile according to the invention, the monopile being provided with multiple vibration devices at a top end thereof, and with a yoke for supporting the monopile;

FIG. 8 shows a close up of the multiple vibration devices at and the top end of the monopile of FIG. 7; and

FIG. 9 shows what an interference pattern of a vibration device may look like, the interference pattern resulting in periodical peaks of a torsional force exerted on the monopile.

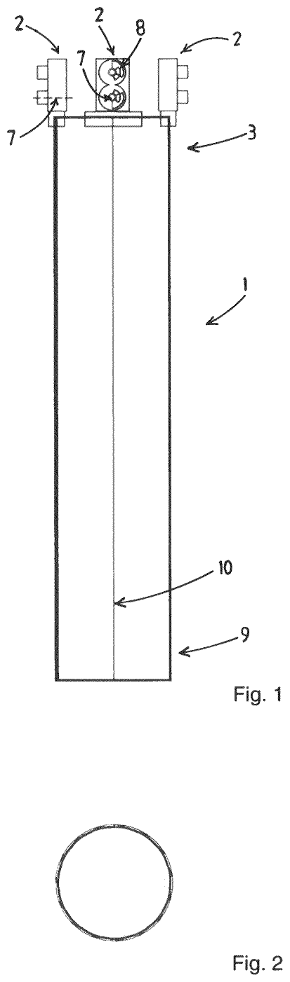

FIG. 1 shows a side view in cross section of a monopile 1 according to the invention. The monopile 1 is provided with multiple vibration devices 2 at a top end 3 thereof. In the embodiment shown, four vibration devices are provided, three of which are depicted in FIG. 1. In the embodiment shown, the axis of rotation 7 of the eccentric masses 8 are directed in a radial direction with respect to the monopile, to enable the vibration devices to generate a circumferentially directed vibration force.

The vibrating is provided by the four vibration devices 2, wherein the vibration devices vibrate a-synchronous, and thus generate peaks (in phase vs out-off phase).

The multiple vibration devices 2 are tuned such that they generate an interference pattern comprising peaks that generate a net circumferential displacement in a revolution direction, and thus revolve the monopile 1 about the longitudinal axis 10 of the monopile 1.

FIG. 2 shows a bottom view of the monopile of FIG. 1. A close up of the bottom end is shown in FIG. 4, which depicts multiple excavating blades 4. The excavating blades 4 alternatingly extend inwards and outwards relative to the circumference of the monopile 1 such that soil is pushed inward and outward during the installation process. Thus, revolving the monopile during the installation process causes removal of the soil below the foot end of the monopile.

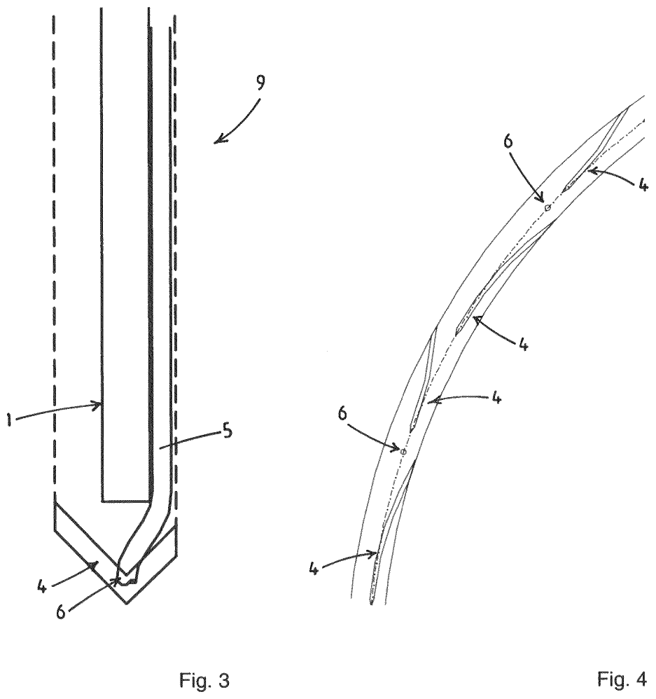

FIG. 3 shows a partial cross sectional side view in close up of the monopile of claim 1, depicting part of an excavating blade 4 and a fluidisation conduit 5. Only part of the fluidisation conduit is shown. The fluidisation conduit 5 extends in the longitudinal direction of the monopile for channeling fluidisation fluid, for example water, to the foot end of the monopile. In the preferred embodiment shown, multiple fluidisation fluid nozzles 6 are provided along the circumference of the foot end of the monopile for dispensing jets of fluidisation fluid at the foot end of the monopile during installation of the monopile, see FIG. 4.

Thus, in the preferred embodiment shown, the monopile 1 has a foot end 9, a top end 3, and a longitudinal axis 10, wherein the monopile is configured to be revolved about the longitudinal axis of the monopile during installation of the monopile in the seabed, and the monopile is at the foot end provided with excavating blades 4 for removing soil from below the foundation pile.

Furthermore, the monopile 1 is provided with fluidisation conduits 5 extending in the longitudinal direction of the monopile for channeling fluidisation fluid, for example water, to the foot end 9 of the monopile and with multiple fluidisation fluid nozzles 6 along the circumference of the foot end 9 of the monopile for dispensing jets of fluidisation fluid at the foot end of the monopile during installation of the monopile.

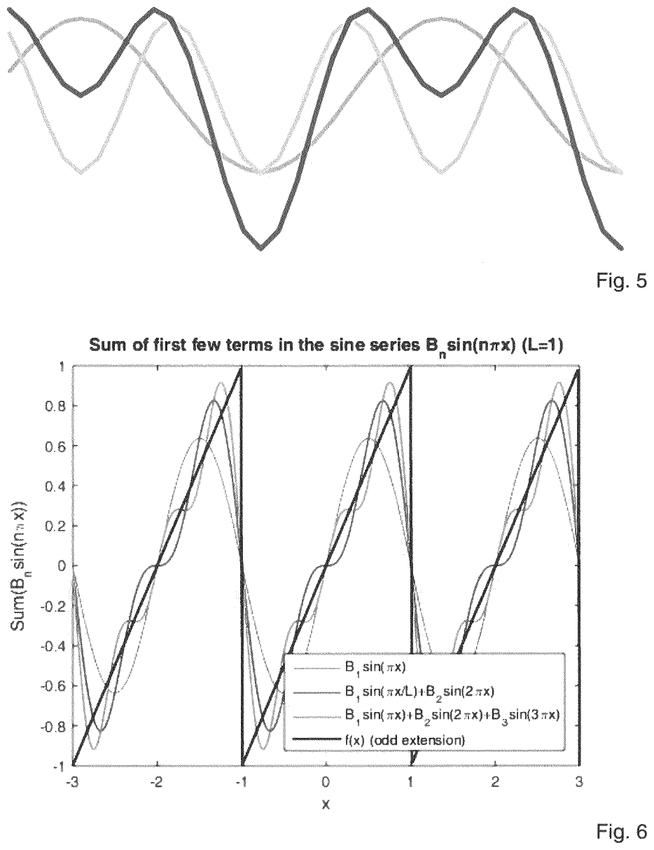

Also, the monopile 1 is configured to be engaged by a pile revolver 11. In the embodiment shown, the pile revolver 11 comprises multiple vibration devices 2 at the top end of the monopile. The multiple vibration devices are tuned such that they generate an interference pattern comprising peaks that generate a net circumferential displacement in a revolution direction, and thus revolve the monopile about the longitudinal axis of the monopile. An example of such an interference pattern is shown in FIG. 5.

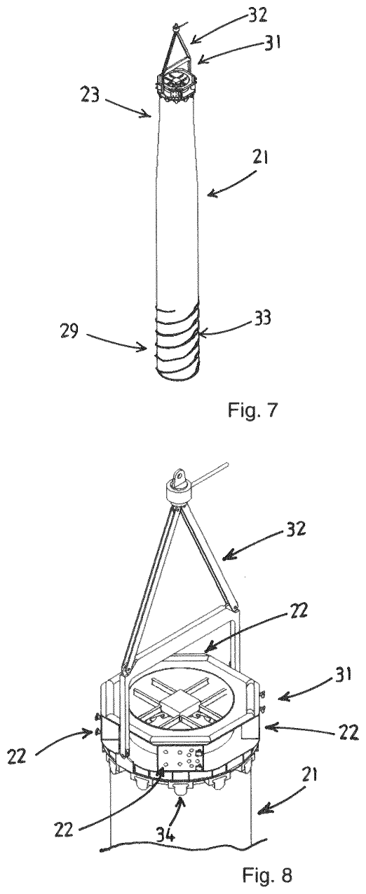

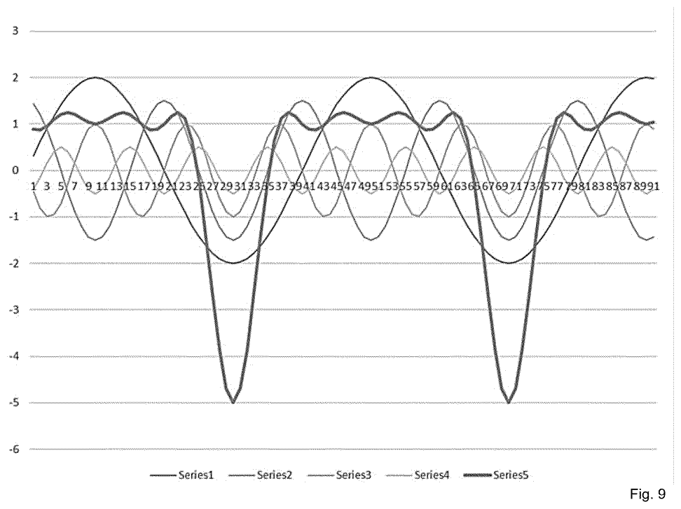

FIG. 7 shows another monopile 21 provided with a pile revolver 31.

The monopile extends along a central axis between a top end 23 and a bottom end 29. The monopile 21 is at an outside surface provided with multiple helical ribs 33 to provide the outside surface of the monopile with a threading to enable the monopile to be screwed into the seabed. In the embodiment shown, the monopile is provided with two intertwined helical ribs. In an alternative embodiment, The foundation pile may be provided with a single helical rib, or with three or more intertwined helical ribs.

The monopile 21 is engaged by a pile revolver 31 at the top end thereof. The pile revolver 31 comprises four vibration devices 22 set up in an annular frame. The pile revolver 31 is furthermore provided with clamping devices 34 at a bottom side for engaging the top end of the foundation pile to secure the pile revolver onto the pile. The pile revolver is furthermore provided with a yoke 32 for lifting the pile revolver using a crane, and for supporting the monopile in an upright position when the pile revolver is clamped on the top end of the monopile. It is submitted that the yoke preferably is configured to allow for rotation of the pile revolver, and thus the foundation pile, relative to the hook of the crane supporting the pile revolver. Thus, the crane can be used for supporting the foundation pile, in addition to or as an alternative to a pile holder or template, during the installation, i.e. while the foundation pile is screwed into the seafloor.

In a preferred embodiment, both the vibration devices and the clamping devices of the pile revolver are hydraulicly operated. In a further embodiment, a hydraulic power source is connected via tubulars with the pie revolver, the tubulars enabling setup of the power source on for example a vessel next to the foundation pile provided with the pile revolver.

It is submitted that the weight of the monopile forces the bottom end thereof into the seafloor, and thus the helical ribs engaging the seafloor, prior to the pile revolver starting to rotate the pile.

For screwing the pile into the seabed, the pile revolver 31 is used to revolve the monopile about its longitudinal axis. The rotation of the pile in combination with the helical ribs engaging the seafloor, forces the pile into the seafloor similar to a screw. Thus, the monopile makes multiple revolutions while being driven into the seabed.

In the embodiment shown, the pile revolver is provided with four individual vibration devices 22, set up along the circumference of the annular frame of the pile revolver. The vibration devices 22 are tuned such that they generate an interference pattern comprising peaks that generate a net circumferential displacement in a revolution direction, and thus revolve the monopile 1 about the longitudinal axis 10 of the monopile 1.

FIG. 5 shows what an interference pattern of vibration devices may look like. The figure shows the output of torsional force generated by two vibration devices vibrating a-synchronous, and their combined output.

FIG. 9 shows what an interference pattern of a vibration device may look like. The figure shows the output of torsional force generated by four rotating eccentric weights, series 1-4, and the combined output, series 5. In the graphic, the combined output shows two dominant peaks of torsional force that generating a net circumferential displacement in a revolution direction, and that thus revolve the monopile 1 about its longitudinal axis in the revolution direction.

In FIG. 9, two dominant peaks of torsional force, i.e. two pile rotating forces, are shown.

FIG. 6 shows what yet another alternative interference pattern of vibration devices may look like. In this configuration, the vibration devices in combination generate a sawtooth cycle, having a dominant torsional force in one direction, this force revolving the monopile.

1.-23. (canceled)

24. A method for installation of an offshore wind turbine foundation monopile in a seabed, the monopile having a foot end, a top end, and a longitudinal axis, the method comprising:
supporting the monopile in an upright position with the foot end on the sea floor; and
revolving the monopile about the longitudinal axis, such that the monopile makes multiple revolutions while being driven into the seabed.

25. The method according to claim 24, wherein the method further comprises using gravitational forces to press the monopile into the soil by providing a weight at the top end of the monopile and/or wherein the method further comprises vibrating the monopile in an axial direction.

26. The method according to claim 24, wherein the method further comprises fluidising the soil by injecting water into the soil at the foot end of the monopile, and allowing the fluidised soil to flow away from below the monopile.

27. The method according to claim 24, wherein the method further comprises vibrating the monopile in a circumferential direction.

28. The method according to claim 27, wherein the frequency of the vibration is between 10 and 500 Hz.

29. The method according to claim 27, wherein the vibration device engages an outside surface of the foundation monopile and/or is mounted at the top end onto the monopile.

30. The method according to claim 27, wherein there are multiple vibration devices, and the multiple vibration devices are tuned such that they generate an interference pattern comprising peaks that generate a net circumferential displacement in a revolution direction, and thus revolve the monopile about the longitudinal axis of the monopile.

31. The method according to claim 27, wherein the vibration is achieved by using a number of individual vibration devices each comprising a hydraulic motor connected to a rotating eccentric mass, and wherein the axis of rotation of the eccentric masses are directed in a radial direction with respect to the monopile, to enable the vibration devices to generate a circumferentially directed vibration force.

32. An offshore wind turbine foundation monopile, the monopile having a foot end, a top end, and a longitudinal axis, wherein the monopile is configured to be revolved about the longitudinal axis of the monopile during installation of the monopile in the seabed, wherein:
the monopile is at the foot end provided with excavating blades for removing soil from below the foundation pile and/or wherein the monopile is at an inside surface and/or an outside surface provided with one or more helical ribs to provide the respective inside and/or outside surface of the monopile with a threading to enable the monopile to be screwed into the seabed and/or to remove soil in an axial direction away from the foot end of the monopile;
and/or
the monopile is provided with one or more fluidisation conduits extending in the longitudinal direction of the monopile for channeling fluidisation fluid to the foot end of the monopile and with multiple fluidisation fluid nozzles along the circumference of the foot end of the monopile for dispensing jets of fluidisation fluid at the foot end of the monopile during installation of the monopile;
and/or
the monopile is configured to be engaged by a pile revolver.

33. The monopile according to claim 32, wherein the monopile is provided with radially extending teeth for cooperating with driving teeth of a pile revolving drive and/or is provided with seats for one or more vibration devices at the top end of the monopile.

34. The monopile according to claim 32, wherein the monopile has a diameter of at least 8 meter, and/or wherein the monopile has a length of at least 30 meter.

35. The monopile according to claim 32, wherein the monopile is at the foot end provided with multiple excavation blades, which excavation blades are mounted to a bottom surface of the monopile or to a flange mounted to the bottom end of the monopile, wherein the excavation blades extend at an angle with the circumference of the monopile to force soil in a radial direction away from below the monopile.

36. The monopile according to claim 35, wherein the excavation blades alternatingly extend inwards and outwards relative to the circumference of the monopile such that soil is pushed inward and outward during the installation process.

37. A monopile installation system, the system comprising;
a monopile support for supporting the monopile in an upright position with the foot end of the monopile on the sea floor; and
a monopile revolver for revolving the monopile about the central axis during installation of the monopile.

38. The system according to claim 37, wherein the monopile revolver comprises multiple vibration devices to be mounted on the top end of the monopile or one or more revolvers configured to engage an outside surface of the monopile and enact a circumferential pile revolving force on the outside surface.

39. The system according to claim 37, wherein the installation system further comprises:
a pile drive for generating an axial pile driving force.

40. The system according to claim 37, wherein the installation system further comprises a monopile, the monopile having a foot end, a top end, and a longitudinal axis, wherein the monopile is configured to be revolved about the longitudinal axis of the monopile during installation of the monopile in the seabed, wherein:
the monopile is at the foot end provided with excavating blades for removing soil from below the foundation pile and/or wherein the monopile is at an inside surface and/or an outside surface provided with one or more helical ribs to provide the respective inside and/or outside surface of the monopile with a threading to enable the monopile to be screwed into the seabed and/or to remove soil in an axial direction away from the foot end of the monopile;
and/or
the monopile is provided with one or more fluidisation conduits extending in the longitudinal direction of the monopile for channeling fluidisation fluid to the foot end of the monopile and with multiple fluidisation fluid nozzles along the circumference of the foot end of the monopile for dispensing jets of fluidisation fluid at the foot end of the monopile during installation of the monopile;
and/or
the monopile is configured to be engaged by a pile revolver.

41. A vessel provided with the system according to claim 37.
